(19) United States
(12) Patent Application Publication
(10) Pub. No.: US 2018/0199061 A1
(43) Pub. Date: Jul. 12, 2018

(54) Method and Apparatus of Advanced Intra Prediction for Chroma Components in Video and Image Coding

(71) Applicants: Kai ZHANG, Beijing (CN); Jicheng AN, Beijing City (CN)

(72) Inventors: Kai ZHANG, Beijing (CN); Jicheng AN, Beijing City (CN)

(21) Appl. No.: 15/742,429

(22) PCT Filed: Jul. 7, 2016
(86) PCT No.: PCT/CN2016/089108

§ 371 Date: Jan. 5, 2018

(30) Foreign Application Priority Data
Jul. 14, 2015 (CN) PCT/CN2015/083991

(51) Int. Cl. H04N 19/593; H04N 19/11; H04N 19/186; H04N 19/176

(52) U.S. Cl. CPC H04N 19/593; H04N 19/176; H04N 19/186; H04N 19/11

(57) ABSTRACT

A method and apparatus of Intra prediction mode coding using one or more extended neighbouring blocks are disclosed. The set of extended neighbouring blocks comprises at least one neighbouring block not corresponding to a top-left neighbouring block and not corresponding to a leftmost-above neighbouring block. One or more Intra prediction mode candidates derived based on Intra prediction modes of the set of extended neighbouring blocks related to the current block are used to predict the current Intra prediction mode of the current block. The set of extended neighbouring blocks may comprise spatial neighbouring blocks of the current block. The set of extended neighbouring blocks may also comprise temporal neighbouring blocks within a collocated block of the current block. Another method and apparatus for unified candidate Intra prediction mode list for different colour components are disclosed.

### CROSS REFERENCE TO RELATED APPLICATIONS

The present invention claims priority to PCT Patent Application, Serial No. PCT/CN2015/083991, filed on Jul. 14, 2015. The PCT Patent Application is hereby incorporated by reference in its entirety.

### TECHNICAL FIELD

The invention relates generally to image and video processing. In particular, the present invention relates to advanced Intra prediction for colour video data in video and image coding.

### BACKGROUND

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC).

In HEVC, one slice is partitioned into multiple coding tree units (CTU). The CTU is further partitioned into multiple coding units (CU) to adapt to various local characteristics. HEVC supports multiple Intra prediction modes and for Intra coded CU, the selected Intra prediction mode is signalled.

According to HEVC, for the luma component, there are 35 possible Intra prediction modes. The Intra prediction mode signalling is done in a predictive fashion by using the Intra prediction modes of neighbouring blocks. For example, Intra prediction mode M_{A} of the neighbouring block A and Intra prediction mode M_{B} of the neighbouring blockB, as shown in FIG. 1 can be used as predictors to code the Intra prediction mode of the current block 110. According to HEVC, M_{A} and M_{B} are represented by parameters candIntraPredModeA and candIntraPredModeB. In the HEVC specification, the candidate mode list denoted as candModeList and the Intra prediction mode of the current block 110 denoted as IntraPredMode[xB][yB] is derived as follows.

A. Derivation of candModeList[x] for x=0, 1 and 2

If candIntraPredModeB is equal to candIntraPredModeA, the following applies:
If candIntraPredModeA is less than 2 (i.e., either Intra_Planar or Intra_DC), candModeList[x] for x=0 . . . 2 is derived as:
   candModeList[0]=Intra_Planar
   candModeList[1]=Intra_DC
   candModeList[2]=Intra_Angular (26)
Otherwise, candModeList[x] for x=0, . . . , 2 is derived as:
   candModeList[0]=candIntraPredModeA
   candModeList[1]=2+((candIntraPredModeA+29) % 32)
   candModeList[2]=2+((candIntraPredModeA−2+1) % 32)

If candIntraPredModeB is not equal to candIntraPredModeA), the following applies:
candModeList[0]=candIntraPredModeA
candModeList[1]=candIntraPredModeB
   If none of candModeList[0] and candModeList[1] is equal to Intra_Planar, then candModeList[2] is set equal to Intra_Planar,
   Otherwise,
      If none of candModeList[0] and candModeList[1] is equal to Intra_DC, candModeList[2] is set equal to Intra_DC,
      Otherwise,
         candModeList[2] is set equal to Intra_Angular (26).

IntraPredMode[xB][yB] is derived by applying the following procedure:
If prev_intra_luma_pred_flag[xB][yB] is equal to 1, IntraPredMode[xB][yB] is set equal to candModeList[mpm_idx].
Otherwise, IntraPredMode[xB][yB] is derived by applying the following ordered steps:
   1) The array candModeList[x], x=0 . . . 2 is modified as the following ordered steps:
      i. When candModeList[0] is greater than candModeList[1], both values are swapped as follows:
         (candModeList[0], candModeList[1])=Swap(candModeList[0], candModeList[1])
      ii. When candModeList[0] is greater than candModeList[2], both values are swapped as follows:
         (candModeList[0], candModeList[2])=Swap(candModeList[0], candModeList[2])
      iii. When candModeList[1] is greater than candModeList[2], both values are swapped as follows:
         (candModeList[1], candModeList[2])=Swap(candModeList[1], candModeList[2])
   2) IntraPredMode[xB][yB] is derived as the following ordered steps:
      i. IntraPredMode[xB][yB]=rem_intra_luma_pred_mode[xB][yB]
      ii. For i equal to 0 to 2, inclusive, when IntraPredMode[xB][yB] is greater than or equal to candModeList[i], the value of IntraPredMode[xB][yB] is incremented by one.

For the chroma component, 5 possible Intra prediction modes are available. As described in the HEVC specification, the chroma Intra prediction mode IntraPredModeC is derived using intra_chroma_pred_mode[xB][yB] and IntraPredMode[xB][yB] as specified in the table below.

| | IntraPredMode[xB][yB] | | | | |
|---|---|---|---|---|---|
| | | | | | X (0 <= |
| intra_chroma_pred_mode[xB][yB] | 0 | 26 | 10 | 1 | X <= 34) |
| 0 | 34 | 0 | 0 | 0 | 0 |
| 1 | 26 | 34 | 26 | 26 | 26 |
| 2 | 10 | 10 | 34 | 10 | 10 |
| 3 | 1 | 1 | 1 | 34 | 1 |
| 4 | 0 | 26 | 10 | 1 | X |

A planar mode is used in HEVC. With this mode, the prediction block is generated as described in sub-clause 8.4.4.2.4 in the HEVC spec. as follows.

8.4.4.2.4 Specification of Intra_Planar Prediction Mode

Inputs to this process are:
neighbouring samples p[x][y], with x, y=−, . . . 1 . . . , 2*nT−1,
a variable nT specifying the transform block size.

Output of this process are:
predicted samples predSamples[x][y], with x, y=0 . . . nT−1.

The values of the prediction samples predSamples[x][y], with x, y=0 . . . nT−1, are derived by:

predSamples[x][y]=((nT−1−x)*p[−1][y]+(x+1)*p[nT][−1]+(nT−1−y)*p[x][−1]+(y+1)*p[−1][nT]+nT)»(Log 2(nT)+1).

LM mode is a new Intra prediction mode proposed during the HEVC development, but not adopted in HEVC for the chroma components. In LM mode, a chroma pixel P_{C}(x,y) is predicted by a corresponding luma pixel P_{L}(x,y). The predictor is calculated as P′_{C}(x,y)=a*P_{L}(x,y)+b, where the parameters a and b can be obtained by a linear regression process using the left and above neighbouring pixels.

There are some other modes developed from LM mode. In LM-L mode, a and b are obtained by a linear regression process only on left neighbouring pixels. In LM-A mode, a and b are obtained by a linear regression process only on above neighbouring pixels. In LM-U mode, a V pixel P_{V}(x,y) is predicted by a corresponding U pixel P_{U}(x,y). The predictor is calculated as P′_{V}(x,y)=a*P_{L}(x,y)+b. a and b are obtained by a linear regression process on left and above neighbouring pixels.

### SUMMARY

A method and apparatus of Intra prediction mode coding using one or more extended neighbouring blocks are disclosed. The set of extended neighbouring blocks comprises at least one neighbouring block not corresponding to a top-left neighbouring block and not corresponding to a leftmost-above neighbouring block. One or more Intra prediction mode candidates derived based on Intra prediction modes of the set of extended neighbouring blocks related to the current block are used to predict the current Intra prediction mode of the current block.

The set of extended neighbouring blocks may correspond to a first extended neighbouring block set consisting of a lower-left block (A0), a bottom-left block (A1), an upper-right block (B0), an above-right block (B1) and an upper-left block (B2) of the current block. The set of extended neighbouring blocks may also correspond to a second extended neighbouring block set consisting of a lower-left block, an upper-right block, an upper-left block, two above-end blocks, two above-middle blocks, two left-end blocks and two left-middle blocks of the current block. In yet another embodiment, the set of extended neighbouring blocks may correspond to a third extended neighbouring block set consisting of one or more temporal neighbouring blocks within a collocated block of the current block.

For the third extended neighbouring block set, the Intra prediction mode candidates derived for a first colour component can be used to predict the current Intra prediction mode of a second colour component. For example, the first colour component and the second colour component may correspond to the luma and chroma components, the luma and U components, the luma and V components, the V and U components, the U and V components, the U and luma components, or the V and luma components respectively.

A candidate Intra prediction mode list can be constructed for a first colour component to predict the current Intra prediction mode of the current block using the Intra prediction mode candidates. The first colour component may correspond to a luma component, a chroma component, U component or V component. The Intra prediction mode candidates derived from the first extended neighbouring block set of the current block having the first colour component can be inserted into the candidate Intra prediction mode list for the first colour component to predict the current Intra prediction mode of the current block having the first colour component. The Intra prediction mode candidates derived from the third extended neighbouring block set of the current block having a second colour component can be inserted into the candidate Intra prediction mode list for the first colour component to predict the current Intra prediction mode of the current block having the first colour component. The second colour component and the first colour component may correspond to the luma and chroma components, the V and U components, or the U and V components respectively.

An index can be signalled for a selected Intra prediction mode candidate for the current Intra prediction mode of the current block from the candidate Intra prediction mode list. The code length of the index signalled can depend on a value of the index. The code length for a smaller index is no longer than that of a larger index. The Intra prediction mode candidates of the set of extended neighbouring blocks can be inserted into the candidate Intra prediction mode list from a beginning location toward an ending location. If a first mode in the Intra prediction modes of the set of extended neighbouring blocks occurs more frequent than a second mode in the Intra prediction modes of the set of extended neighbouring blocks, the first mode is inserted into the candidate Intra prediction mode list before the second mode. Also, one or more adjacent modes of the Intra prediction modes of the set of extended neighbouring blocks can be inserted into the candidate Intra prediction mode list. One or more modes selected from LM mode, LM-L mode and LM-A mode can be inserted into the candidate Intra prediction mode list for a chroma component. Also, LM-U mode can be inserted into the candidate Intra prediction mode list for U component.

A method and apparatus for unified candidate Intra prediction mode list for different colour components are disclosed. According to this method, a candidate Intra prediction mode list for a current block is constructed and a set of Intra prediction mode codes representing indices of candidate Intra prediction modes of the candidate Intra prediction mode list is determined. The current Intra prediction mode of the current block is encoded or decoded using a same set of Intra prediction mode codes for the current block regardless of whether the current block corresponds to a luma component or a chroma component. In one embodiment, all Intra prediction modes are inserted into the candidate Intra prediction mode list according to an order of all the Intra prediction modes. If an Intra prediction mode is already in the candidate Intra prediction mode list, this Intra prediction mode is not inserted into the candidate Intra prediction mode list Intra prediction mode candidates derived based on Intra prediction modes of neighbouring blocks related to the current block can be inserted into the candidate Intra prediction mode list. Any redundant Intra prediction mode candidate in the candidate Intra prediction mode list can be removed from the candidate Intra prediction mode list. New Intra prediction mode Intra_Planar_Above mode, Intra_Planar_Left mode or both can be used for Intra prediction of a block. Furthermore, Intra_Planar_Above mode, Intra_Planar_Left mode, or both can be inserted into the candidate Intra prediction mode list. A selected code from the set of Intra prediction mode codes can be signalled for a selected Intra prediction mode candidate to predict the current Intra prediction mode of the current block.

### BRIEF DESCRIPTION OF THE DRAWINGS

FIG. 1 illustrates an example of neighbouring blocks used in Intra prediction mode coding for High Efficiency Video Coding (HEVC) standard.

FIG. 2 illustrates an example of extended neighbouring block set comprising spatial neighbouring blocks related to the current block used for Intra prediction mode coding according to an embodiment of the present invention.

FIG. 3 illustrates another example of extended neighbouring block set comprising spatial neighbouring blocks related to the current block used for Intra prediction mode coding according to an embodiment of the present invention.

FIG. 4 illustrates yet illustrates an example of extended neighbouring block set comprising temporal neighbouring blocks within a collated block of the current block used for Intra prediction mode coding according to an embodiment of the present invention.

FIG. 5 illustrates an example of index signalling for an Intra prediction mode selected from the candidate Intra prediction mode list.

FIG. 6 illustrates an example of inserting Intra prediction modes of neighbouring blocks into the candidate Intra prediction mode list according to an order of the neighbouring blocks, where the order is A1, B1, A0, B0, and B2.

FIG. 7 illustrates an example of inserting Intra prediction modes of neighbouring blocks into the candidate Intra prediction mode list according to an order of occurring frequency.

FIG. 8 illustrates an example of inserting modes into the candidate Intra prediction mode list for the luma component according to the order shown.

FIG. 9 illustrates an example of inserting modes into the candidate Intra prediction mode list for the U/V component according to the order shown.

FIG. 10A illustrates an example of coding tree to code the candidate Intra prediction mode list for the U component.

FIG. 10B illustrates an example of coding tree to code the candidate Intra prediction mode list for the V component.

FIG. 11 illustrates an example of coding tree to code the candidate Intra prediction mode list for both luma and chroma components according to an embodiment of the present invention.

FIG. 12 illustrates an exemplary flowchart for Intra prediction mode coding according to an embodiment of the present invention.

FIG. 13 illustrates another exemplary flowchart for Intra prediction mode coding according to an embodiment of the present invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

In the following description, Y component is identical to luma component, U component is identical to Cb component and V component is identical to Cr component.

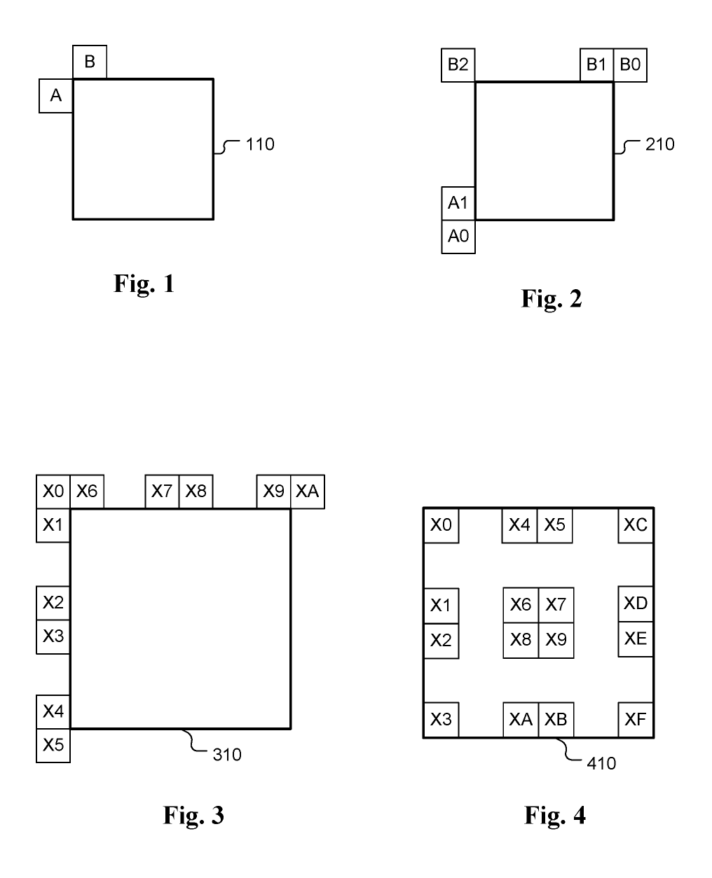

An advanced Intra prediction mode coding method is disclosed in this application. In one embodiment, an extended neighbouring block set is used, where the extended neighbouring block set includes at least one neighbouring block not corresponding to block A (i.e., top-left neighbouring block) and not corresponding to block B (i.e., leftmost-above neighbouring block) in FIG. 1. In one example, the extended neighbouring blocks including a lower-left block (A0), a bottom-left block (A1), an upper-right block (B0), an above-right block (B1) and an upper-left block (B2) of the current block 210 as shown in FIG. 2 are used to predict the Intra prediction mode of the current block 210. The current block 210 may correspond to a luma block, a chroma block, a U block or a V block dependent on the respective context in the following disclosure. For convenience, the set of neighbouring blocks in FIG. 2 is referred as the first neighbouring block set.

Other neighbouring blocks may also be used. For example, a lower-left block (X5), an upper-right block (XA), an upper-left block (X0), two above-end blocks (X6, X9), two above-middle blocks (X7, X8), two left-end blocks (X1, X4) and two left-middle blocks (X2, X3) of the current block 310 shown in FIG. 3 may also be used to predict the Intra prediction mode of the current block 310. In FIG. 3, the current block 310 may correspond to a luma block, a chroma block, a U block or a V block dependent on the respective context in the following disclosure. For convenience, the set of neighbouring blocks in FIG. 3 is referred as the second neighbouring block set.

In another embodiment, any combination of four corner blocks (X0, X3, XC, XF), four centre blocks (X6, X7, X8, X9), and two centre boundary blocks (X4/X5, X1/X2, XA/XB, XD/XE) for each side of four sides of the collocated block as shown in FIG. 4 may also be used to predict the Intra prediction mode of the current block 410. The blocks X0, X1, X2, . . . , X9, XA, XF in FIG. 4 are referred as the temporal neighbouring blocks of the current block 410. In FIG. 4, the current block 410 may correspond to a luma block, a chroma block, a U block or a V block dependent on the respective context in the following disclosure. For convenience, the set of neighbouring blocks in FIG. 4 is referred as the third neighbouring block set.

In one embodiment, one or more of the first-chroma Intra prediction modes of temporal neighbouring first-chroma blocks X0, X1, X2, . . . , X9, XA, XF of the current second-chroma block as shown in FIG. 4 are used to predict the Intra prediction mode for the second-chroma component. The first-chroma component and the second-chroma component may correspond to U and V respectively, or V and U respectively.

In one embodiment, one or more of the chroma Intra prediction modes of temporal neighbouring chroma blocks X0, X1, X2, . . . , X9, XA, XF of the current luma block as shown in FIG. 4 are used to predict the luma Intra prediction mode. The chroma component may correspond to U or V.

In one embodiment, a candidate Intra prediction mode list is constructed for Intra prediction mode of a colour component. The colour component may correspond to the luma, the chroma, U or V.

In one embodiment, one or more of the Intra prediction modes of a colour component associated with neighbouring blocks A0, A1, B0, B1, and B2 as shown in FIG. 2 are inserted into the candidate Intra prediction mode list for the Intra prediction mode of the colour component. The colour component may correspond to the luma, the chroma, U or V.

In one embodiment, one or more of the Intra prediction modes of a colour component associated with neighbouring blocks X0, X1, X2, . . . , X9, XA as shown in FIG. 3 are inserted into the candidate Intra prediction mode list for the Intra prediction mode of the colour component. The colour component may correspond to the luma, the chroma, U or V.

In one embodiment, one or more of the luma Intra prediction modes of temporal neighbouring luma blocks X0, X1, X2, . . . , X9, XA, . . . , XF of the current non-luma block as shown in FIG. 4 are inserted into the candidate Intra prediction mode list for Intra prediction mode of the current non-luma block. The luma Intra prediction mode of a temporal neighbouring luma block can be inserted as the first candidate in the candidate Intra prediction mode list for the Intra prediction mode of the current non-luma block. The non-luma block may correspond to a chroma block, a U block or a V block.

In one embodiment, one or more of the first-chroma Intra prediction modes of temporal neighbouring first-chroma blocks X0, X1, X2, . . . , X9, XA, . . . XF of the current second-chroma block as shown in FIG. 4 are inserted into the candidate Intra prediction mode list for the Intra prediction mode of the second-chroma component. The first-chroma Intra prediction mode of a temporal neighbouring first-chroma block can be inserted as the first candidate in the candidate Intra prediction mode list for the Intra prediction mode of the second-chroma component. In another embodiment, the first-chroma Intra prediction mode of a temporal neighbouring first-chroma block can be inserted as a candidate in the candidate Intra prediction mode list for Intra prediction mode of the second-chroma component after the luma Intra prediction mode of a temporal neighbouring luma block. The first-chroma component and second-chroma component may correspond to the U and V components respectively. The first-chroma component and second-chroma component may correspond to the V and U components respectively.

In one embodiment, one or more of the U Intra prediction modes of temporal neighbouring U blocks X0, X1, X2, . . . , X9, XA, . . . , XF of the current luma block as shown in FIG. 4 are inserted into the candidate Intra prediction mode list for the luma Intra prediction mode. The U Intra prediction mode of a temporal neighbouring U block can be inserted as the first candidate in the candidate Intra prediction mode list for the Intra prediction mode of the luma component. In another embodiment, the U Intra prediction mode of a temporal neighbouring U block can be inserted as a candidate in the candidate Intra prediction mode list for the Intra prediction mode of the luma component after the V Intra prediction mode of a temporal neighbouring V block.

In one embodiment, one or more of the V Intra prediction modes of temporal neighbouring V blocks X0, X1, X2, . . . , X9, XA, . . . , XF of the current luma block as shown in FIG. 4 are inserted into the candidate Intra prediction mode list for the luma Intra prediction mode. The V Intra prediction mode of a temporal neighbouring V block can be inserted as the first candidate in the candidate Intra prediction mode list for the Intra prediction mode of the luma component. In another embodiment, the V Intra prediction mode of a temporal neighbouring V block can be inserted as a candidate in the candidate Intra prediction mode list for the Intra prediction mode of the luma component after the U Intra prediction mode of a temporal neighbouring U block.

In one embodiment, pruning process can be applied to the candidate Intra prediction mode list so that there are no duplicated modes in entries of the candidate Intra prediction mode list.

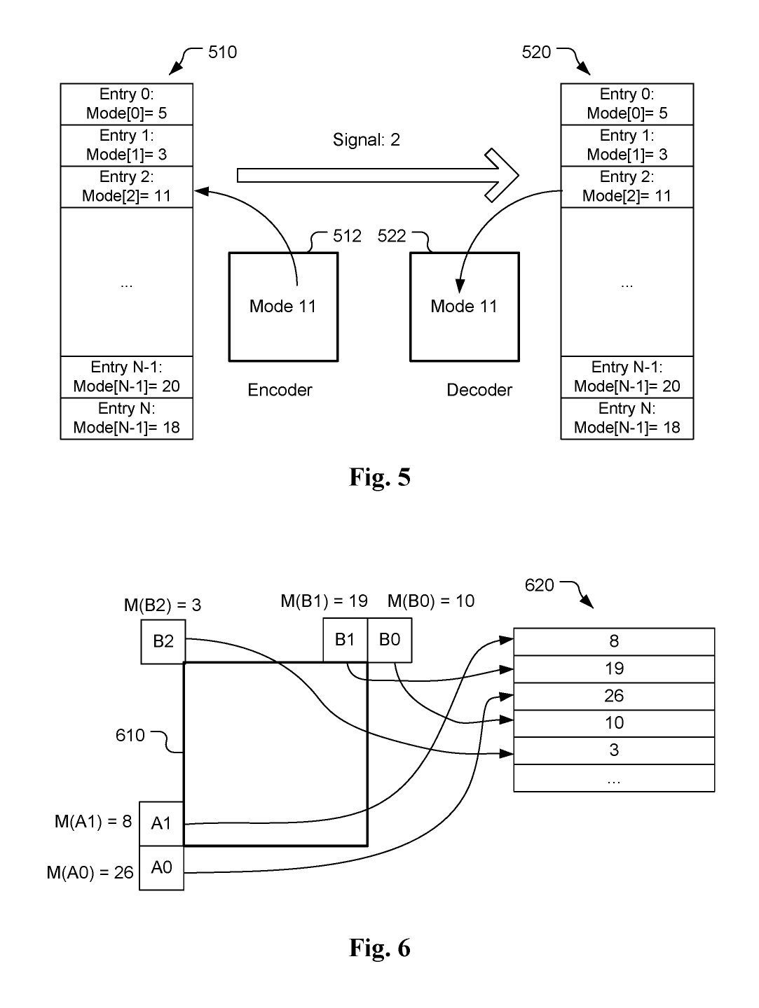

The index of the Intra prediction mode in the candidate Intra prediction mode list of the current block can be signalled from the encoder to the decoder. Accordingly, the decoder can reconstruct the Intra prediction mode by retrieving the mode in the candidate Intra prediction mode list with the signalled index. FIG. 5 illustrates an example of the mode signalling and reconstructing process. A candidate Intra prediction mode list 510 is maintained at the encoder side. Also, a corresponding candidate Intra prediction mode list 520 is maintained at the decoder side. If mode 11 is selected for a current block 512, the corresponding entry for mode 11 in the candidate Intra prediction mode list 510 is identified (i.e., Entry 2). Accordingly, signalling to indicate Entry 2 is sent to the decoder so that the decoder can use mode 11 for the current block 522 being decoded.

In one embodiment, the code length of the signalled index of the Intra prediction mode in the candidate Intra prediction mode list depends on the value of the index. For example, an index in the candidate Intra prediction mode list with a smaller value can be signalled with a shorter code length, and an index in the candidate Intra prediction mode list with a larger value can be signalled with a longer code length. In another example, the code length for a smaller index is no longer than that of a larger index.

In one embodiment, the Intra prediction modes for the luma component and chroma component are coded in the same manner. For example, all possible Intra prediction modes are inserted into the candidate Intra prediction mode list according to a specific order, and the indices of candidate Intra prediction modes for luma and chroma components are coded with the same coding tree (e.g., the coding tree shown in FIG. 11).

The Intra prediction modes of the neighbouring blocks can be inserted into the candidate Intra prediction mode list from the top toward the bottom of the list according to an order of the neighbouring blocks. FIG. 6 illustrates an example of inserting Intra prediction modes of neighbouring blocks into the candidate Intra prediction mode list orderly. In the example, the Intra prediction modes of five neighbouring blocks of the current block 610 are inserted into the candidate Intra prediction mode list 620 and the ordering of the neighbouring blocks is {A1, B1, A0, B0, B2}.

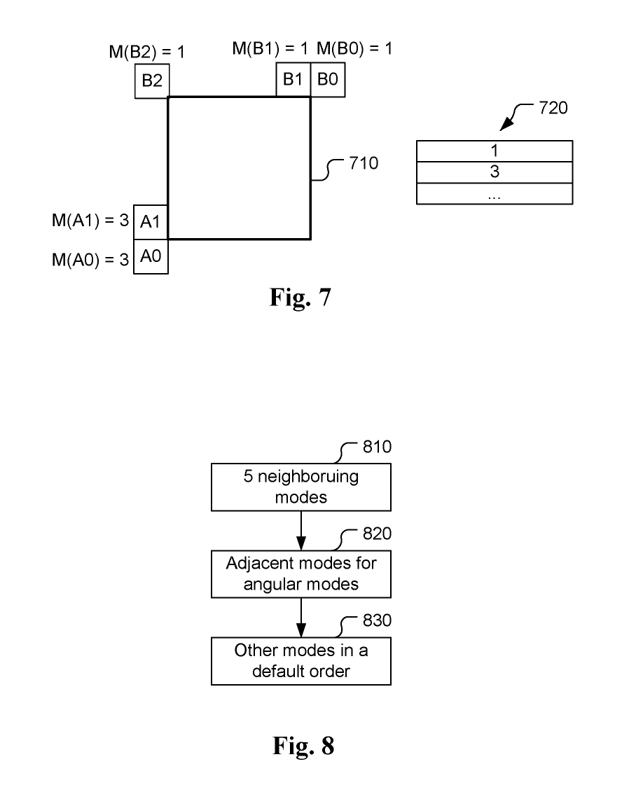

If an Intra prediction mode M1 occurs more frequently in neighbouring blocks than another Intra prediction mode M2, mode M1 is inserted before mode M2 in the candidate Intra prediction mode list. FIG. 7 illustrates an example of inserting Intra prediction modes of neighbouring blocks of the current block 710 into the candidate Intra prediction mode list 720. Mode 1 appears three times in block B0, B1, and B2. On the other hand, Mode 3 appears twice in block A0 and A1. Therefore, Mode 1 is inserted into the candidate Intra prediction mode list 720 before mode 3.

In one embodiment, adjacent modes for Intra prediction modes of neighbouring blocks are inserted into the candidate Intra prediction mode list. The adjacent modes are inserted only if the mode of a neighbouring block is an angular mode. For example, if mode 10 is a mode of a neighbouring block and it is inserted into the candidate Intra prediction mode list, then modes 11 and 9 are inserted into the candidate Intra prediction mode list.

In one embodiment, one or more modes from LM, LM-L, and LM-A are inserted into the chroma candidate Intra prediction mode list. As described in HEVC, the chroma Intra prediction is derived based reconstructed neighbouring luma pixels of a collocated luma block for these modes. For the LM mode, both reconstructed neighbouring luma pixels above and to the left are used. For the LM-L mode, only reconstructed neighbouring luma pixels to the left are used. For the LM-A mode, only reconstructed neighbouring luma pixels above are used.

In one embodiment, mode LM-U is inserted into the candidate Intra prediction mode list for the V component. The LM-U is similar to the LM mode. However, instead of using reconstructed neighbouring luma pixels, the reconstructed neighbouring U pixels of a collocated U block are used to derive Intra prediction for a current V block.

All possible Intra prediction modes can be inserted into the candidate Intra prediction mode list according to an order of Intra prediction modes. If a same mode is already in the candidate Intra prediction mode list, the mode is not inserted into the candidate Intra prediction mode list. FIG. 8 illustrates an example of inserting Intra prediction modes into the candidate Intra prediction mode list for the luma component according to an order of these Intra prediction modes. The modes associated these five neighbouring modes 810 are inserted first, followed by adjacent modes for angular modes 820, and further followed by other modes in a default order 830.

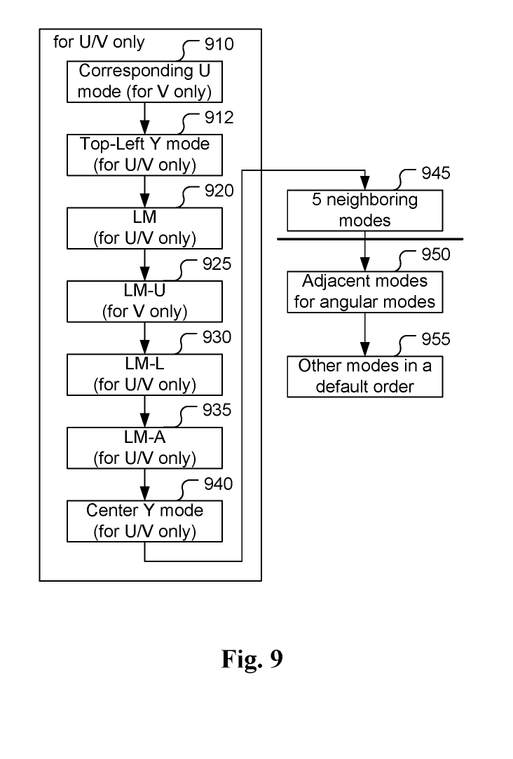

FIG. 9 illustrates an example of inserting modes into the candidate Intra prediction mode list for the chroma component according to an order of these Intra prediction modes. The ordering from beginning to end in FIG. 9 corresponds to Corresponding U mode (for V only) 910, Top-Left Y mode (for U/V only) 912, LM (for U/V only) 920, LM-U (for V only) 925, LM-L (for U/V only) 930, LM-A (for U/V only) 935, Center Y mode (for U/V only) 940, five neighbouring modes 945, adjacent modes for angular modes 950, and other modes in a default order 955.

A new Intra prediction mode, Intra_Planar_Left mode is also disclosed. The prediction block for Intra_Planar_Left mode is generated as follows:

predSamples[x][y]=((nT−1−x)*p[−1][y]+(x+1)*p[nT][−1]+(nT»1))»Log 2(nT).

In the above equation, nT corresponds to the block size, p[−1][y] corresponds to a reconstructed pixel in the left column of the current block, and p[nT][−1] corresponds to the rightmost pixel in the above row of the current block. Another new Intra prediction mode, Intra_Planar_Above mode is also disclosed. The prediction block for Intra_Planar_Above mode is generated as follows:

predSamples[x][y]=((nT−1−y)*p[x][−1]+(y+1)*p[−1][nT]+(nT»1))»Log 2(nT).

In the above equation, p[x][−1] corresponds to a reconstructed pixel in the above row of the current block, and p[−1][nT] corresponds to the bottom pixel in the left column of the current block. The Intra Planar mode uses the previously reconstructed pixels of the above row and the left column to generate the prediction samples by bilinear interpolation. On the other hand, Intra_Planar_Above mode and Intra_Planar_Left only use the respective above row and the left column to generate the prediction samples by bilinear interpolation. Intra_Planar_Left mode can be inserted into the candidate Intra prediction mode list. Similarly, Intra_Planar_Above mode can also be inserted into the candidate Intra prediction mode list. Also, both Intra_Planar_Above mode and Intra_Planar_Left mode can be inserted into the candidate Intra prediction mode list.

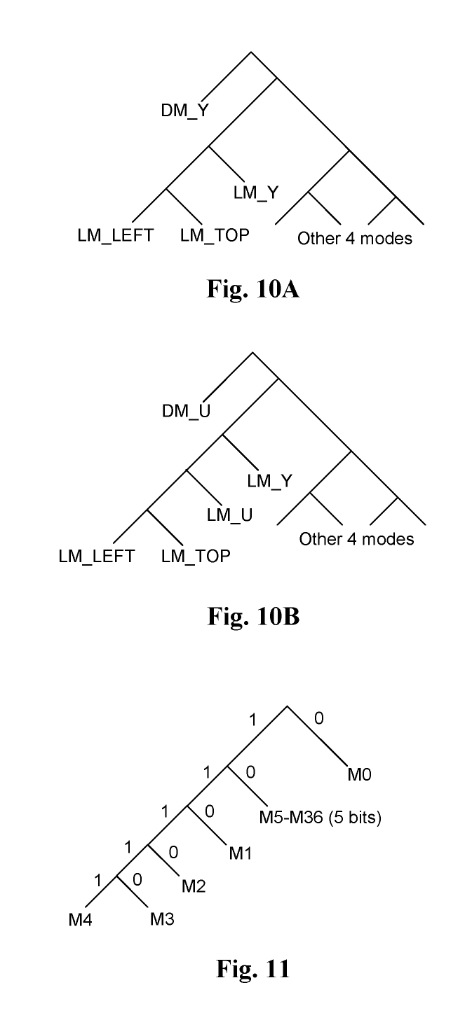

As mentioned previously, the Intra prediction mode selected for a block needs to be signalled from an encoder to a decoder. The Intra prediction modes are mapped to a binary string using a coding tree. For the luma component, the existing Intra prediction mode coding uses a total of 35 modes consisting of 3 MPM modes (most probably modes) and 32 remaining modes. The coding trees for the existing Intra prediction for U and V are shown in FIG. 10A and FIG. 10B respectively. The parsing procedures for Y, U and V components are different.

In one embodiment, the index of the candidate Intra prediction mode list is coded with the coding tree shown in FIG. 11, where the coding tree includes 37 modes. The same coding tree can be used for the luma component as well as the chroma component. The 37 modes may correspond to the 35 Intra modes as defined in HEVC plus the Intra_Planar_Left mode and the Intra_Planar_Above mode. In another example, the modes included in the candidate Intra prediction mode list may be derived from one or more blocks in the first, second and third neighbouring block set. As shown in FIG. 5, a selected Intra prediction mode in the candidate Intra prediction mode list is signalled according to the mode index (e.g. mode index=2 for mode 11). Accordingly, the coding tree corresponds to a set of Intra prediction mode codes representing mode indices of candidate Intra prediction modes of the candidate Intra prediction mode list.

The code of the index of the candidate Intra prediction mode list can be treated as binarization code in the CABAC process.

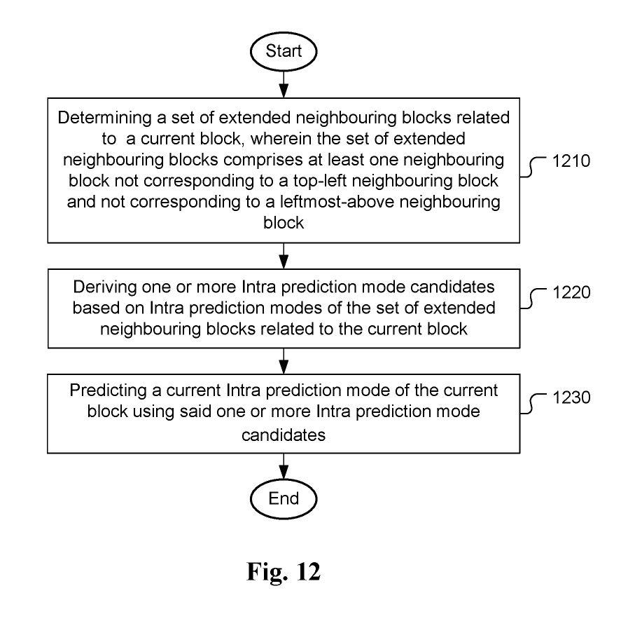

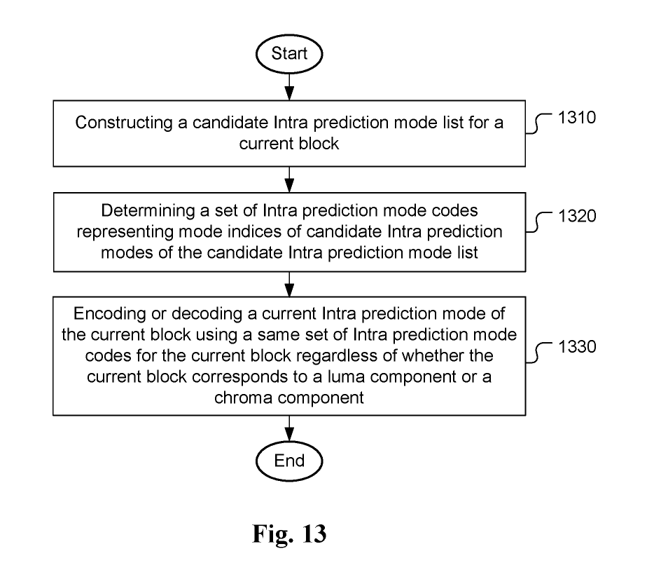

FIG. 12 illustrates an exemplary flowchart for Intra prediction mode coding according to an embodiment of the present invention. According to this method, a set of extended neighbouring blocks related to a current block is determined in step 1210. The set of extended neighbouring blocks comprises at least one neighbouring block not corresponding to a top-left neighbouring block and not corresponding to a leftmost-above neighbouring block. One or more Intra prediction mode candidates are derived based on Intra prediction modes of the set of extended neighbouring blocks related to the current block in step 1220. A current Intra prediction mode of the current block is then encoded or decoded using said one or more Intra prediction mode candidates in step 1230.

FIG. 13 illustrates another exemplary flowchart for Intra prediction mode coding according to an embodiment of the present invention. According to this method, a candidate Intra prediction mode list for a current block is reconstructed in step 1310. A set of Intra prediction mode codes corresponding to the candidate Intra prediction mode list is determined in step 1320. A current Intra prediction mode of the current block is encoded or decoded using a same set of Intra prediction mode codes for the current block regardless of whether the current block corresponds to a luma component or a chroma component in step 1330.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of Intra prediction mode coding, the method comprising:
determining a set of extended neighbouring blocks related to a current block, wherein the set of extended neighbouring blocks comprises at least one neighbouring block not corresponding to a top-left neighbouring block (A) and not corresponding to a leftmost-above neighbouring block (B);
deriving one or more Intra prediction mode candidates based on Intra prediction modes of the set of extended neighbouring blocks related to the current block; and
predicting a current Intra prediction mode of the current block using said one or more Intra prediction mode candidates.

2. The method of claim 1, wherein the set of extended neighbouring blocks related to the current block corresponds to a first extended neighbouring block set consisting of a lower-left block (A0), a bottom-left block (A1), an upper-right block (B0), an above-right block (B1) and an upper-left block (B2) of the current block.

3. The method of claim 1, wherein the set of extended neighbouring blocks related to the current block corresponds to a second extended neighbouring block set consisting of a lower-left block (X5), an upper-right block (XA), an upper-left block (X0), two above-end blocks (X6, X9), two above-middle blocks (X7, X8), two left-end blocks (X1, X4) and two left-middle blocks (X2, X3) of the current block.

4. The method of claim 1, wherein the set of extended neighbouring blocks related to the current block corresponds to a third extended neighbouring block set consisting of one or more temporal neighbouring blocks within a collocated block of the current block.

5. The method of claim 4, wherein the third extended neighbouring block set consists of four corner blocks, four centre blocks, and two centre boundary blocks for each side of four sides of the collocated block.

6. The method of claim 5, wherein said one or more Intra prediction mode candidates derived based on the Intra prediction modes of the third extended neighbouring block set of the current block having a first colour component are used to predict the current Intra prediction mode of the current block having a second colour component.

7. The method of claim 6, wherein the first colour component and the second colour component corresponds to a luma component and a chroma component respectively, the luma component and U component respectively, the luma component and V component respectively, the V component and U component respectively, the U component and V component respectively, the U component and the luma component respectively, or the V component and the luma component respectively.

8. The method of claim 1, wherein a candidate Intra prediction mode list is constructed for a first colour component to predict the current Intra prediction mode of the current block using said one or more Intra prediction mode candidates.

9. The method of claim 8, wherein the first colour component corresponds to a luma component, a chroma component, U component or V component.

10. The method of claim 9, wherein the set of extended neighbouring blocks related to the current block corresponds to a first extended neighbouring block set consisting of a lower-left block (A0), a bottom-left block (A1), an upper-right block (B0), an above-right block (B1) and an upper-left block (B2) of the current block.

11. The method of claim 10, wherein said one or more Intra prediction mode candidates of the current block having the first colour component are inserted into the candidate Intra prediction mode list for the first colour component to predict the current Intra prediction mode of the current block having the first colour component.

12. The method of claim 9, wherein the set of extended neighbouring blocks related to the current block corresponds to a third extended neighbouring block set consisting of four corner blocks, four centre blocks, and two centre boundary blocks for each side of four sides of a collocated block of the current block.

13. (canceled)

14. (canceled)

15. (canceled)

16. The method of claim 1, wherein an index is signalled for a selected Intra prediction mode candidate for the current Intra prediction mode of the current block from said one or more Intra prediction mode candidates, and wherein a code length of the index signalled depends on a value of the index.

17. The method of claim 16, wherein a first code length of a first index is not longer than a second code length of a second index if the first index is smaller than the second index.

18. The method of claim 1, wherein said one or more Intra prediction mode candidates are inserted into a candidate Intra prediction mode list from a beginning location toward an ending location.

19. The method of claim 18, wherein if a first mode in the Intra prediction modes of the set of extended neighbouring blocks occurs more frequent than a second mode in the Intra prediction modes of the set of extended neighbouring blocks, the first mode is inserted into the candidate Intra prediction mode list before the second mode.

20. The method of claim 18, wherein one or more adjacent modes of the Intra prediction modes of the set of extended neighbouring blocks are inserted into the candidate Intra prediction mode list.

21. The method of claim 1, wherein one or more modes selected from LM mode, LM-L mode and LM-A mode are inserted into a candidate Intra prediction mode list for a chroma component.

22. The method of claim 1, wherein LM-U mode is inserted into a candidate Intra prediction mode list for V component.

23. An apparatus for Intra prediction mode coding, the apparatus comprising one or more electronic circuits or processors configured to:
determine a set of extended neighbouring blocks related to a current block, wherein the set of extended neighbouring blocks comprises at least one neighbouring block not corresponding to a top-left neighbouring block (A) and not corresponding to a leftmost-above neighbouring block (B);
derive one or more Intra prediction mode candidates based on Intra prediction modes of the set of extended neighbouring blocks related to the current block; and
predict a current Intra prediction mode of the current block using said one or more Intra prediction mode candidates.

24-32. (canceled)
